(19) United States
(12) Patent Application Publication
(10) Pub. No.: US 2025/0097736 A1
(43) Pub. Date: Mar. 20, 2025

(54) TRANSMITTING DATASETS IN WIRELESS COMMUNICATION SYSTEMS

(71) Applicant: ZTE Corporation, Shenzhen (CN)

(72) Inventors: Guozeng ZHENG, Shenzhen (CN); Zhaohua LU, Shenzhen (CN); Huahua XIAO, Shenzhen (CN); Wenfeng LIU, Shenzhen (CN); Lun LI, Shenzhen (CN); Yong LI, Shenzhen (CN); Yuxin WANG, Shenzhen (CN)

(21) Appl. No.: 18/970,456

(22) Filed: Dec. 5, 2024

Related U.S. Application Data
(63) Continuation of application No. PCT/CN2023/073211, filed on Jan. 19, 2023.

(51) Int. Cl. H04W 24/02; H04B 17/309; H04B 17/318; H04W 64/00

(52) U.S. Cl. CPC H04W 24/02; H04B 17/328; H04B 17/346; H04W 64/00

(57) ABSTRACT

Techniques are described for communicating datasets, between wireless devices and network nodes, to train artificial intelligence (AI) and/or machine learning (ML) models, which can be used in both training and inference stages, to improve system performance. An example method for wireless communication includes receiving, by a wireless device, a dataset from a network node, wherein the dataset comprises a plurality of data samples and is associated with a first information. In another example, the example method further includes transmitting, to the network node, a request for the dataset.

### CROSS-REFERENCE TO RELATED APPLICATIONS

This application is a continuation of International Patent Application No. PCT/CN2023/073211, filed on Jan. 19, 2023, the disclosure of which is incorporated herein by reference in its entirety.

### TECHNICAL FIELD

This disclosure is directed generally to digital wireless communications.

### BACKGROUND

Mobile telecommunication technologies are moving the world toward an increasingly connected and networked society. In comparison with the existing wireless networks, next generation systems and wireless communication techniques will need to support a much wider range of use-case characteristics and provide a more complex and sophisticated range of access requirements and flexibilities.

Long-Term Evolution (LTE) is a standard for wireless communication for mobile devices and data terminals developed by 3rd Generation Partnership Project (3GPP). LTE Advanced (LTE-A) is a wireless communication standard that enhances the LTE standard. The 5th generation of wireless system, known as 5G, advances the LTE and LTE-A wireless standards and is committed to supporting higher data-rates, large number of connections, ultra-low latency, high reliability and other emerging business needs.

### SUMMARY

Methods and systems for communicating datasets to initialize and utilize processing methods (e.g., to train and use artificial intelligence (AI) and/or machine learning (ML) models) are described. In an example, the datasets are associated with dataset description information, and can be employed for both initialization (e.g., training) and utilization (e.g., inference) stages of the processing methods. The described embodiments provide procedures and protocols that enable datasets to be efficiently exchanged between network nodes and wireless devices.

In an example aspect, a method for wireless communication includes transmitting, by a network node, a dataset to a wireless device, the dataset comprising a plurality of data samples and being associated with a first information.

In another example aspect, a method for wireless communication includes receiving, by a wireless device, a dataset from a network node, the dataset comprising a plurality of data samples and being associated with a first information.

In yet another example aspect, the above-described methods are embodied in the form of processor-executable code and stored in a non-transitory computer-readable storage medium. The code included in the computer readable storage medium when executed by a processor, causes the processor to implement the methods described in this patent document.

In yet another example aspect, a device that is configured or operable to perform the above-described methods is disclosed.

The above and other aspects and their implementations are described in greater detail in the drawings, the descriptions, and the claims.

### BRIEF DESCRIPTION OF THE DRAWINGS

FIG. 1 shows an example of modules that generate different channel representations.

FIG. 2-3 show flowcharts for example methods of wireless communication.

FIG. 4 shows a block diagram of an example hardware platform that may be a part of a network device or a communication device.

FIG. 5 shows an example of wireless communication including a base station (BS) and user equipment (UE) based on some implementations of the disclosed technology.

### DETAILED DESCRIPTION

In today's emerging wireless communication systems, artificial intelligence (AI) and/or machine learning (ML) technologies are being rapidly integrated to improve system performance in a variety of ways, e.g., optimize throughput, manage interference, support an increased number of users, and the like. In general, AI/ML systems typically require large amounts of data for training the underlying models. However, it may be difficult and expensive to collect this amount of data from a wireless communication system, especially when the AI/ML model is to be deployed on the wireless terminal side (e.g., UE, wireless device, etc.). In these scenarios, the information collected by the network side (e.g., base station, gNodeB, core network function, etc.) during network operation can be transmitted to the terminal in order to train the AI/ML models. The described embodiments provide procedures and protocols that enable datasets to be efficiently exchanged between network nodes and wireless devices.

In this document, datasets refer to multiple data samples (with or without annotated and auxiliary information) that are exchanged between network nodes and wireless devices. In the described embodiments, the dataset represents a finite number of data samples that are associated with dataset description information (or more generally, first information), which enables both the network side and the wireless side to parse the dataset correctly and achieve a common understanding of what the dataset represents. The data samples in the dataset are generated based on certain configurations or scenarios (or more generally, second information). The datasets (and equivalently, subsets of the dataset) can be used for different purposes, e.g., for initializing a processing method, algorithm, or module (e.g., training an AI/ML model or assign some initial values to the processing method, algorithm, or module based on the dataset) or for monitoring or evaluating whether the processing method, algorithm, module, or AI/ML model performs as expected (e.g., with respect to a performance metric like accuracy). The processing method, algorithm, or model is associated with model information (or more generally, third information) that includes an identifier for the dataset, or multiple identifiers for each of multiple data subsets, that were used to initialize the processing method, algorithm, or model, as well as an indication of performance. Furthermore, the model information includes scenarios or configurations for which the processing method, algorithm, or model is applicable (or more generally, fourth information). This application configuration may be transmitted from the terminal side to the network side.

The example headings for the various sections below are used to facilitate the understanding of the disclosed subject matter and do not limit the scope of the claimed subject matter in any way. Accordingly, one or more features of one example section can be combined with one or more features of another example section. The described embodiments are applicable to both data transmission from the network side to the terminal side and data transmission from the terminal side to the network side. Furthermore, 5G terminology is used for the sake of clarity of explanation, but the techniques disclosed in the present document are not limited to 5G technology only, and may be used in wireless systems that implemented other protocols.

### 1 Examples of Dataset Identification

In some embodiments, a dataset that is communicated between the network side and the terminal side is associated with dataset description information. The dataset description information includes an identifier that is linked to the dataset. In an example, the identifier is assigned within a Public Land Mobile Network (PLMN). The dataset description information (or more generally, the first information) further includes the data types for the data samples in the dataset and/or a configuration associated with the generation of the data samples (or more generally, the second information) in the dataset.

In some embodiments, information included in the dataset description information is known to both the network side and the wireless side prior to the exchange of any datasets. In these scenarios, the network side may transmit datasets without any dataset description information other than an identifier to the dataset, the terminal side will already know how to interpret the received dataset once the identifier is received.

In some embodiments, the network side may transmit dataset description information but without data samples. Furthermore, the dataset description information may only include an identifier for the dataset. In some embodiments, the network side may further indicate an address (e.g., IP address or URL) to indicate where to download the data samples for the dataset.

In some embodiments, the network side is configured to provide an identifier for any dataset communicated between the terminal side and the network side. In an example, the network side may generate a dataset, associate an identifier with the dataset, and then transmit it to the terminal side. In another example, the terminal side may generate a dataset that is transmitted to the network side. Then, network side may assign an identifier to the dataset. The identifier is subsequently sent to the terminal side.

In some embodiments, the dataset may include multiple subsets. In these cases, each of multiple data subsets is associated with an identifier that is different from the identifier of the dataset. In an example, each subset of data (or data subset) includes data samples of different data types. In another example, each data subset includes data samples of the same data type, but each data subset was generated based on a different configuration (or scenario).

### 2 Examples of Dataset Description Information

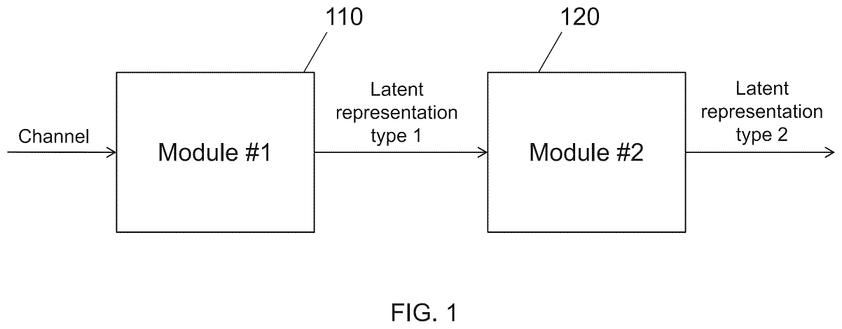

In some embodiments, the dataset that is transmitted between the network side and the terminal side includes multiple data samples. In this case, each of the data samples may be of one or more data types. In an example, the data type is one of the following:
Channel matrix. The channel matrix data type can either be a channel impulse response (CIR) data type or a channel frequency response (CFR) data type.
Channel precoding matrix. In an example, the channel precoding matrix can be the basis vectors selected from a predefined codebook (or precoding basis codebook vectors). In another example, the channel precoding matrix can be a linear combination of basis vectors selected from a predefined codebook. Herein, the linear combination coefficients of the basis vectors can include amplitude and phase information.
Latent representation of the channel. The latent representation of the channel can be generated for a channel matrix or a channel precoding matrix. FIG. 1 shows an example of the latent representations that can be generated from a channel matrix or a channel precoding matrix. The latent representations include:
   A compressed channel, which is generated by module #1 (110) in FIG. 1, is a latent representation of the channel matrix or the channel precoding matrix.
   A reconstructed channel, which is generated by module #2 (120) in FIG. 1, is a latent representation of the compressed channel matrix or the compressed channel precoding matrix. In an example, the modules #1 and #2 can be an AI/ML model, a processing method, or an algorithm.
Signal-to-noise and interference ratio (SINR). In an example, the associated reference signal information and/or the transmission reception point (TRP) of the SINR may also be provided as part of the dataset description information.
Reference signal received power (RSPP). In an example, the associated reference signal information and/or the TRP of the RSPP may also be provided as part of the dataset description information.
Reference signal received path power (RSRPP). In an example, the associated reference signal information and/or the TRP of the RSRPP is also provided as part of the dataset description information.
Timing information. The timing information includes (i) time of arrival (TOA), which is the transmission time of a radio signal between a terminal and a TRP, and/or (ii) the reference signal time difference (RSTD). In an example, the associated reference signal information and/or the TRP of the TOA and/or the RSTD are also provided as part of the dataset description information.
Line-of-sight (LOS) indicator. The LOS indicator is the confidence level of the link between a terminal and a transmission reception point (TRP) being line-of-sight. In an example, the associated reference signal information and/or TRP of the LOS indicator is also provided as part of the dataset description information.
The location or position of the wireless device (e.g., UE).

In some embodiments, a data sample in the dataset includes multiple data types (e.g., that are structured using <pair> or <tuple> data structures) with the multiple data types being associated with each other. In an example, if the data sample is to be used for training an AI/ML model (or more generally, a processing method that is implemented in the wireless device), the data sample includes a first part that corresponds to the input to the model and a second part that corresponds to the label for that input. In another example, a data sample that includes multiple data types includes one of the following:
One channel matrix (or one channel precoding matrix) and one metric (e.g., SINR/RSRP/RSRPP/TOA/RSTD).
One channel matrix (or one channel precoding matrix) and one compressed channel.
One channel matrix (or one channel precoding matrix) and multiple compressed channels, with each of the multiple compressed channels having a different number of dimensions, a different size in each of the dimensions, a different quantization method, and/or a different quantization resolution.
One channel matrix (or one channel precoding matrix), one compressed channel, and one reconstructed channel.
One channel matrix (or one channel precoding matrix), multiple compressed channels, and multiple reconstructed channels, with each of the multiple compressed channels and multiple reconstructed channels having a different number of dimensions, a different size in each of the dimensions, a different quantization method, and/or a different quantization resolution. In this case, the number of compressed channels and the number of reconstructed channels are identical. Furthermore, each compressed channel in the multiple compressed channels is paired with a corresponding reconstructed channel in the multiple reconstructed channels.

In some embodiments, the generation condition of the data samples, e.g., a specific configuration (e.g., AWGN noise with 50 dB SNR, or fading channel with 10 dB SINR, etc.) or scenario (e.g., indoor scenario, outdoor downtown scenario, etc.) that was used to generate the data samples in a dataset is included as part of the dataset description information. In an example, the generation condition of the data samples can be specified using one or more of the following values, parameters, configurations, or scenarios:
physical cell identity (or global cell identity)
carrier frequency
bandwidth
sub-carrier spacing
number of resource blocks (RBs) per sub-band
density of reference signals in the frequency domain and/or time domain
number of antenna ports
number of antenna ports in a first dimension and a second dimension
a quantization method and/or a quantization resolution for each element in a channel matrix data type
a selection method for the basis vectors from a predefined codebook for the channel precoding matrix data type
a quantization method and/or a quantization resolution for a linear combination coefficient for a channel precoding matrix data type
for a latent representation of the channel data type:
   a dimension of the latent representation
   an order (or priority) of elements in the latent representation to be included in the dataset
   a size of each dimension of the latent representation
   a quantization method and/or a quantization resolution for each element in the latent representation
a quantization method and/or a quantization resolution for other data types

In some embodiments, an exhaustive list of parameters for the generation condition is transmitted with the dataset. In other embodiments, the network side and the terminal side have predetermined scenarios available, and the generation scenario includes the specific scenario selected and any parameters that are different from the default parameters for that scenario.

### 3 Examples of a Data Request

In some embodiments, the terminal side (e.g., UE, wireless device) transmits request signaling for a dataset from the network side (e.g., base station, network device, gNB).

In some embodiments, the request signaling includes the purpose for the dataset. In an example, the purpose of the dataset is for initializing an AI/ML model or a processing method (e.g., the training stage). In another example, the purpose of the dataset is for monitoring or evaluating an AI/ML model or a processing method (e.g., the inference stage). In this latter example, the terminal may request data samples (in addition to data samples for training) in order to evaluate the efficacy of the model. Herein, the number of data samples required for model monitoring/evaluation is typically less than the number of data samples required for model training.

In some embodiments, the request signaling includes a requested data type for the dataset. Furthermore, the request signaling may request multiple data types in the dataset.

In some embodiments, the request signaling indicates that a single data sample does not have to provide all the requested data types. For example, a dataset may contain two data samples—the first data sample including a channel matrix and a TOA, and the second data sample including only the channel matrix. This type of dataset may be used for training an AI/ML model in a semi-supervised or unsupervised learning framework, which requires training data that include the data corresponding to the model input but not necessarily data (e.g., training label) corresponding to the model output.

In some embodiments, the request signaling includes a requested number of data samples. Herein, the requested number of data samples corresponds to the number of samples the network side includes in the dataset that is transmitted to the terminal side. In an example, the requested number of data samples is an exact value. In another example, the requested number of data samples is a value range. In some scenarios, the requested number of data samples may be large, e.g., when used for training an AI/ML model with a large number of parameters.

### 4 Examples of the Dataset and Request Transmission Channel

In some embodiments, the dataset can be transmitted in a broadcast channel.

In some embodiments, the dataset transmitted in the broadcast channel uses one or more system information blocks (SIBs), and data samples of different data types are transmitted in different SIBs. In an example, multiple SIBs are used to transmit the same dataset, e.g., all the data samples across the multiple SIBs are associated with the same dataset identifier. In another example, when the dataset is divided into data subsets, each SIB of the multiple SIBs is used to transmit one of the data subsets.

In some embodiments, the request signaling is transmitted using a dedicated channel. In an example, the dedicated channel is a physical random access channel (PRACH) or a physical uplink control channel (PUCCH). In another example, different data types are associated with different channels, e.g., different channels correspond to PRACHs with different preambles or the same PRACH in different time and/or frequency occasions.

### 5 Examples of AI/ML Model Information

In some embodiments, the terminal side uses the dataset received from the network side to train an AI/ML model (or more generally, to initialize a processing method). In this case, the terminal side conveys the AI/ML model information (or more generally, the third information) to the network side about the AI/ML model or the processing method.

In some embodiments, the model information indicates which dataset(s) have been used to train the AI/ML model. In an example, the model information includes an identifier for a dataset that is used to train the AI/ML model. In other embodiments, the dataset includes multiple data subsets, and the model information includes information that identifies which of the multiple data subsets were used to train the AI/ML model. In this example, one or more identifiers for each of the multiple data subsets used are transmitted as part of the model information to the network side by the terminal side.

In some embodiments, the model information includes an indication of performance of the AI/ML model for one or more particular datasets (or data subsets) being used to train the model. In an example, the indication of performance is the model effectiveness, the model inference accuracy, and/or the model prediction accuracy. In another example, if the model output is predicted TOA value(s), the performance indication can be the timing error between the predicated TOA value(s) and ideal (or ground-truth) TOA values. In yet another example, if the model output is a reconstructed channel, the performance indication can be the similarity between the reconstructed channel and channel matrix/precoding matrix.

In some embodiment, the model information includes applicable conditions (or more generally, the fourth information) for the AI/ML model. In an example, the applicable conditions correspond to certain configurations or scenarios for using the AI/ML model. In another example, the applicable conditions correspond to the model effectiveness, the model inference accuracy, and/or the model prediction accuracy meeting the performance requirements of a framework in which the AI/ML model is to be deployed.

In some embodiments, the model information excludes applicable conditions for an AI/ML model, and it is assumed that the applicable conditions are identical to the generation conditions for the dataset that was used to train the AI/ML model. In other embodiments, the applicable conditions may be similar to the generation conditions, but not identical. In this case, only the applicable condition parameters that are different from the parameters of the generation conditions are included in the model information.

In some embodiments, the applicable conditions for an AI/ML model are extensions of the generation conditions, which corresponds to data augmentation being applied to the dataset that was used to train the AI/ML model. For example, the generation conditions for the dataset specify the data samples were generated for 1024 subcarriers, but the applicable conditions specify that the AI/ML model is valid for 512, 1024, and 2048 subcarriers. In an example, this determination is based on the model effectiveness, the model inference accuracy, and/or the model prediction accuracy in the various scenarios.

In some embodiments, the applicable conditions for the AI/ML model can be specified using one or more of the following values, parameters, configurations, or scenarios:
carrier frequency
bandwidth
sub-carrier spacing
number of resource blocks (RBs) per sub-band
density of reference signals in the frequency domain and/or time domain
number of antenna ports
number of antenna ports in a first dimension and a second dimension

In some embodiments, if the terminal side receives a dataset from the network side for monitoring or evaluating an AI/ML model or a processing method at terminal side, one of the following information may be sent back to network side from the terminal side:
Inference results based on the dataset. For example, when the dataset is used as an input to the AI/ML model or processing method, the output of the AI/ML model or processing method is reported to the network side.
Performance indication based on the dataset (e.g., the model inference accuracy and/or the model prediction accuracy). In an example, if the model output is predicted TOA value(s), the performance indication is the timing error between the predicated TOA value(s) and ideal (or ground-truth) TOA values. In another example, if the model output is a reconstructed channel, the performance indication is the similarity between the reconstructed channel and channel matrix/precoding matrix.
Validation indicator. In an example, the terminal side evaluates the model performance based on the dataset, and transmits a validation indicator to the network side. The validation indicator being 0 indicates that the model is no longer valid, whereas the validation indicator being 1 indicates that the model is valid (e.g., meets a defined requirement or threshold).

In some embodiments, if the terminal side receives a dataset from the network side for initializing an AI/ML model or a processing method, the network side may further indicate the information about required (or suggested) AI/ML model/processing method. The information may include one of the following
storage size of the model
number or range of the weighting parameters of the model
inference latency of the model (or execution time of the model for one inference)
quantization method and/or quantization resolution corresponding to the model output
the number of dimensions and/or the size of each dimension corresponding to the model output

### 6 Example Embodiments of the Disclosed Technology

The described embodiments provide, inter alia, the following features:
1. A dataset is transmitted between network side and terminal side. In some embodiments, a dataset may be associated with dataset description information.
   1.a. In some embodiments, the dataset description information includes an identifier linked to the dataset. The identifier ensures there is a common understanding for interactions between the network side and the terminal side.
   1.b. In some embodiments, one dataset may include different subsets. Each subset of the dataset may also be associated with an identifier.
   2. The dataset includes multiple data samples.
   2.a. One data sample may include one or multiple data types.
   2.b. In some embodiments, one data sample includes multiple data types and the multiple data types are associated with each other.
   3. In some embodiments, terminal side may send request signaling to receive the dataset from network side.
   3.a. The request signaling may include the purpose for the dataset.
   3.b. The request signaling may include requested data type for the dataset.
   4. In some embodiments, the dataset can be transmitted in a broadcast channel.
   5. In some embodiments, if terminal side has an AI/ML model and the AI/ML model is trained based on a dataset, the terminal side should inform/disclose model information to network side.
   5.a. In some embodiments, the model information should indicate which dataset(s) has been used for training the AI/ML model. For example, it can be indicated by the identifier associated with the dataset.
   5.b. In some embodiments, the model information may further include applicable conditions of the AI/ML model.

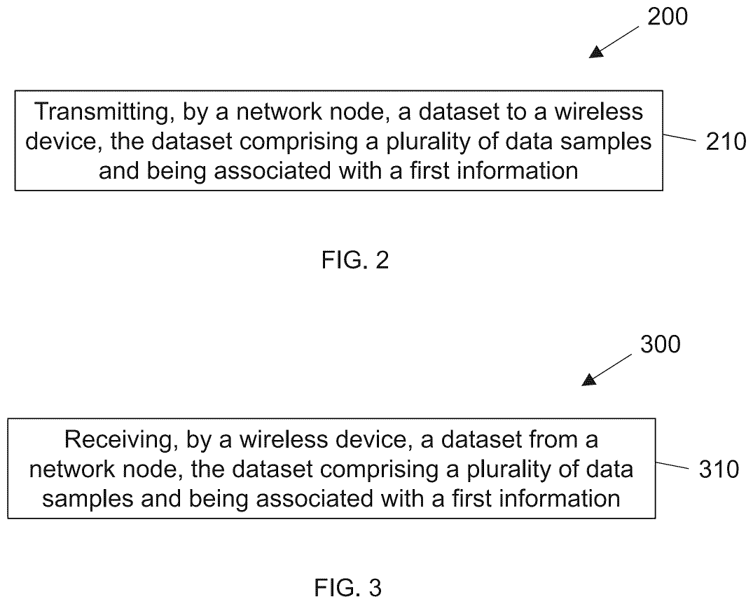

FIG. 2 shows a flowchart for an example method 200 for wireless communication. The method includes, at operation 210, transmitting, by a network node, a dataset to a wireless device, the dataset comprising a plurality of data samples and being associated with a first information.

FIG. 3 shows a flowchart for an example method 300 for wireless communication. The method includes, at operation 310, receiving, by a wireless device, a dataset from a network node, the dataset comprising a plurality of data samples and being associated with a first information.

In some embodiments, the method 300 further includes the operation of transmitting, to the network node, a request for the dataset.

In some embodiments, as described in Section 3, the request includes at least one of a purpose for the dataset, a requested data type, or a required number of the plurality of data samples in the dataset.

In some embodiments, as described in Section 4, the request is transmitted in a dedicated channel, which includes a physical random access channel (PRACH) or a physical uplink control channel (PUCCH).

In some embodiments, as described in Section 2, the first information corresponds to the dataset description information. In an example, the first information comprises an identifier for the dataset. In another example, the first information comprises (a) a second information associated with a generation of the plurality of data samples or (b) at least one data type for the plurality of data samples. In this latter example, the second information corresponds to a scenario or configuration for generating the data samples, as described in Section 2.

In some embodiments, the method 300 further includes the operation of transmitting, to the network node, a third information associated with a processing method. As described in Section 5, the third information corresponds to the model information, and the processing method corresponds to an AI/ML model, and more generally, to an algorithm or module.

In some embodiments, the third information comprises an indication of a performance of the processing method using at least one of the one or more data subsets.

In some embodiments, the third information comprises a fourth information associated with an application of the processing method. As described in Section 5, the fourth information corresponds to a scenario or configuration for the applicability of the processing method. In an example, the fourth information associated with the application of the processing method is identical to a second information associated with a generation of the dataset. In another example, the fourth information associated with the application of the processing method is different from a second information associated with a generation of the dataset.

In some embodiments, the disclosed technology provides the following technical solutions:
1. A method of wireless communication, comprising receiving, by a wireless device, a dataset from a network node, wherein the dataset comprises a plurality of data samples and is associated with a first information.
2. The method of solution 1, further comprising transmitting, to the network node, a request for the dataset.
3. The method of solution 2, wherein the request comprises a purpose for the dataset.
4. The method of solution 2, wherein the request comprises a requested data type.
5. The method of solution 2, wherein the request comprises a required number of the plurality of data samples in the dataset.
6. The method of solution 2, wherein the request is transmitted in a dedicated channel.
7. The method of solution 6, wherein the dedicated channel comprises a physical random access channel (PRACH) or a physical uplink control channel (PUCCH).
8. The method of solution 1, wherein the first information comprises an identifier for the dataset.
9. The method of solution 1, wherein the first information comprises (a) a second information associated with a generation of the plurality of data samples or (b) at least one data type for the plurality of data samples.
10. The method of solution 9, wherein the at least one data type is one of a channel impulse response (CIR), a channel frequency response (CFR), a channel precoding matrix, a compressed channel representation, a reconstructed channel representation, a signal-to-interference-and-noise ratio (SINR), a reference signal received power (RSRP), a reference signal received path power (RSRPP), a time of arrival (TOA), a reference signal time difference (RSTD), a line-of-sight (LOS) indicator, or a position of the wireless device.
11. The method of solution 9, wherein at least one data sample of the plurality of data samples comprises at least a first data type and a second data type such that the second data type is associated with the first data type.
12. The method of solution 9, wherein the second information associated with the generation of the plurality of data samples comprises at least one of a physical cell identity, a carrier frequency, a bandwidth, a sub-carrier spacing, a number of resource blocks (RBs) per sub-band, a density of reference signals in a time-domain, a density of reference signals in a frequency-domain, a number of antenna ports, or the number of antenna ports in a first dimension and a second dimension.
13. The method of solution 1, wherein the plurality of data samples is divided into multiple data subsets, and wherein the first information comprises (a) an identifier for each of the multiple data subsets or (b) a second information associated with a generation of data samples in each of the multiple data subsets.
14. The method of solution 1, wherein the dataset is received in a broadcast channel.
15. The method of solution 14, wherein the dataset is received in one or more system information blocks (SIBs) in the broadcast channel.
16. The method of solution 15, wherein the plurality of data samples comprises a first set of data samples of a first data type and a second set of data samples of a second type, and wherein transmitting the dataset comprises receiving the first set of data samples in a first SIB; and receiving the second set of data samples in a second SIB different from the first SIB.
17. The method of solution 1, comprising transmitting, to the network node, a third information associated with a processing method.
18. The method of solution 17, wherein the third information comprises an identifier for a dataset that is used to initialize the processing method.
19. The method of solution 17, wherein the dataset comprises multiple data subsets, wherein one or more data subsets of the multiple data subsets is used to initialize the processing method, and wherein the third information comprises an identifier for each of the one or more data subsets.
20. The method of solution 19, wherein the third information comprises an indication of a performance of the processing method using at least one of the one or more data subsets.
21. The method of solution 17, wherein the third information comprises a fourth information associated with an application of the processing method.
22. The method of solution 21, wherein the fourth information associated with the application of the processing method is identical to a second information associated with a generation of the dataset.
23. The method of solution 21, wherein the fourth information associated with the application of the processing method is different from a second information associated with a generation of the dataset.
24. The method of solution 21, wherein the fourth information associated with the application of the processing method comprises at least one of a physical cell identity, a carrier frequency, a bandwidth, a sub-carrier spacing, a number of resource blocks (RBs) per sub-band, a density of reference signals in a time-domain, a density of reference signals in a frequency-domain, a number of antenna ports, or the number of antenna ports in a first dimension and a second dimension.
25. An apparatus for wireless communication comprising a processor, configured to implement a method recited in one or more of solutions 1 to 23.
26. A non-transitory computer readable program storage medium having code stored thereon, the code, when executed by a processor, causing the processor to implement a method recited in one or more of solutions 1 to 23.

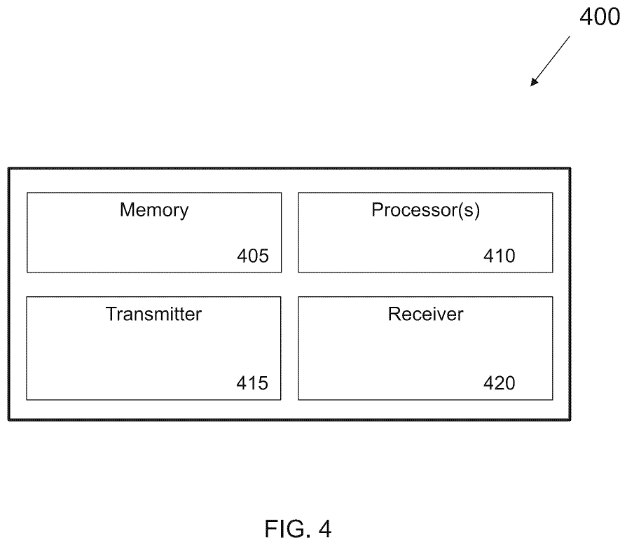

FIG. 4 shows a block diagram of an example hardware platform 400 that may be a part of a network device (e.g., base station) or a communication device (e.g., a user equipment (UE)). The hardware platform 400 includes at least one processor 410 and a memory 405 having instructions stored thereupon. The instructions upon execution by the processor 410 configure the hardware platform 400 to perform the operations described in FIGS. 1 to 3 and in the various embodiments described in this patent document. The transmitter 415 transmits or sends information or data to another device. For example, a network device transmitter can send a message to a user equipment. The receiver 420 receives information or data transmitted or sent by another device. For example, a user equipment can receive a message from a network device.

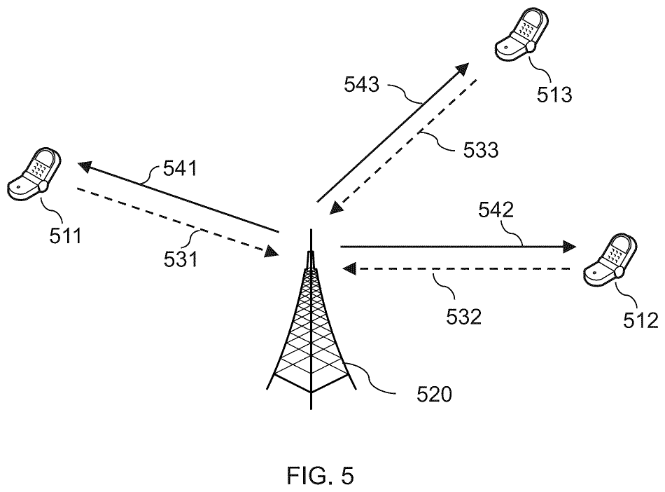

The implementations as discussed above will apply to a wireless communication protocol or system. FIG. 5 shows an example of a wireless communication system (e.g., a 5G or NR cellular network) that includes a base station 520 and one or more user equipment (UE) 511, 512 and 513. In some embodiments, the UEs access the BS (e.g., the network) using a communication link to the network (sometimes called uplink direction, as depicted by dashed arrows 531, 532, 533), which then enables subsequent communication (e.g., shown in the direction from the network to the UEs, sometimes called downlink direction, shown by arrows 541, 542, 543) from the BS to the UEs. In some embodiments, the BS send information to the UEs (sometimes called downlink direction, as depicted by arrows 541, 542, 543), which then enables subsequent communication (e.g., shown in the direction from the UEs to the BS, sometimes called uplink direction, shown by dashed arrows 531, 532, 533) from the UEs to the BS. The UE may be, for example, a smartphone, a tablet, a mobile computer, a machine to machine (M2M) device, an Internet of Things (IoT) device, and so on.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

What is claimed is:

1. A method of wireless communication, comprising:
transmitting, by a wireless device to a network node, a request for a dataset; and
receiving, from the network node, the dataset, wherein the dataset comprises a plurality of data samples and is associated with a first information.

2. The method of claim 1, wherein the request comprises at least one of a purpose for the dataset, a requested data type, or a required number of the plurality of data samples in the dataset.

3. The method of claim 1, wherein the request is transmitted in a dedicated channel comprising a physical random access channel (PRACH) or a physical uplink control channel (PUCCH).

4. The method of claim 1, wherein the first information comprises (a) an identifier for the dataset, (b) a second information associated with a generation of the plurality of data samples, or (c) at least one data type for the plurality of data samples.

5. The method of claim 4, wherein the at least one data type is one of: a channel impulse response (CIR), a channel frequency response (CFR), a channel precoding matrix, a compressed channel representation, a reconstructed channel representation, a signal-to-interference-and-noise ratio (SINR), a reference signal received power (RSRP), a reference signal received path power (RSRPP), a time of arrival (TOA), a reference signal time difference (RSTD), a line-of-sight (LOS) indicator, or a position of the wireless device.

6. The method of claim 4, wherein at least one data sample of the plurality of data samples comprises at least a first data type and a second data type such that the second data type is associated with the first data type.

7. The method of claim 4, wherein the second information associated with the generation of the plurality of data samples comprises at least one of: a physical cell identity, a carrier frequency, a bandwidth, a sub-carrier spacing, a number of resource blocks (RBs) per sub-band, a density of reference signals in a time-domain, a density of reference signals in a frequency-domain, a number of antenna ports, or the number of antenna ports in a first dimension and a second dimension.

8. The method of claim 1, wherein the plurality of data samples is divided into multiple data subsets, and wherein the first information comprises (a) an identifier for each of the multiple data subsets or (b) a second information associated with a generation of data samples in each of the multiple data subsets.

9. The method of claim 1, wherein the dataset is received in one or more system information blocks (SIBs) in a broadcast channel.

10. The method of claim 9, wherein the plurality of data samples comprises a first set of data samples of a first data type and a second set of data samples of a second type, and wherein transmitting the dataset comprises:
receiving the first set of data samples in a first SIB; and
receiving the second set of data samples in a second SIB different from the first SIB.

11. The method of claim 1, comprising:
transmitting, to the network node, a third information associated with a processing method.

12. The method of claim 11, wherein the third information comprises an identifier for a dataset that is used to initialize the processing method.

13. The method of claim 11, wherein the dataset comprises multiple data subsets, wherein one or more data subsets of the multiple data subsets is used to initialize the processing method, and wherein the third information comprises an identifier for each of the one or more data subsets or an indication of a performance of the processing method using at least one of the one or more data subsets.

14. The method of claim 11, wherein the third information comprises a fourth information associated with an application of the processing method, and wherein the fourth information comprises at least one of: a physical cell identity, a carrier frequency, a bandwidth, a sub-carrier spacing, a number of resource blocks (RBs) per sub-band, a density of reference signals in a time-domain, a density of reference signals in a frequency-domain, a number of antenna ports, or the number of antenna ports in a first dimension and a second dimension.

15. The method of claim 14, wherein the fourth information associated with the application of the processing method is identical to a second information associated with a generation of the dataset.

16. The method of claim 14, wherein the fourth information associated with the application of the processing method is different from a second information associated with a generation of the dataset.

17. An apparatus for wireless communication, implemented at a wireless device, the apparatus comprising:
one or more processors configured to:
transmit, to a network node, a request for a dataset; and
receive, from the network node, wherein the dataset comprises a plurality of data samples and is associated with a first information.

18. The apparatus of claim 17, wherein the request comprises at least one of a purpose for the dataset, a requested data type, or a required number of the plurality of data samples in the dataset.

19. The apparatus of claim 17, wherein the first information comprises (a) an identifier for the dataset, (b) a second information associated with a generation of the plurality of data samples, or (c) at least one data type for the plurality of data samples.

20. The apparatus of claim 17, wherein the plurality of data samples is divided into multiple data subsets, and wherein the first information comprises (a) an identifier for each of the multiple data subsets or (b) a second information associated with a generation of data samples in each of the multiple data subsets.
